(19) United States
(12) Patent Application Publication
(10) Pub. No.: US 2008/0212072 A1
(43) Pub. Date: Sep. 4, 2008

(54) Photothermal Test Camera Provided With An Optical Device For Extending A Laser Beam Section

(75) Inventors: Marc Piriou, Chalon Sur Saone (FR); Laurent Legrandjacques, Spottswood Place-Lynchburg, VA (US)

Correspondence Address: CONNOLLY BOVE LODGE & HUTZ LLP, 1875 EYE STREET, N.W., SUITE 1100, WASHINGTON, DC, 20036, US

(73) Assignee: AREVA NP, Place de la Coupole (FR)

(21) Appl. No.: 11/912,917

(22) PCT Filed: Mar. 30, 2006
(86) PCT No.: PCT/FR06/00700

§ 371 Date: Oct. 29, 2007

(30) Foreign Application Priority Data
Apr. 28, 2005 (FR) 05 04330

(51) Int. Cl. G01J 3/00

(52) U.S. Cl. 356/51

(57) ABSTRACT

The inventive photothermal test camera (16) is provided with a laser beam (4) shaping system (22) comprising a device (40) for extending the laser beam section in such a way that a heating area (2) extended in a direction (D) is formed on the surface of a testable piece (1), an array (8) of infrared sensors (10) for detecting a infrared radiation transmitted by a detection area (3) on the surface (1a) of the piece (1) with respect to the heating area (2) and a unit (46) for processing signals transmitted by the infrared sensors (10) in such a way that a thermographic image of the piece (1) surface (1a) is produced by scanning said surface (1a) with the aid of the heating area (2). An extending device (40) is embodied in the form of an optical device. Said invention can be used for non-destructive testing.

The present invention relates to a photothermal examination camera of the type comprising:
a system for shaping a laser beam comprising a device for extending the section of the beam to form a heating area extended in one direction on the surface of an item to be examined,
a matrix of infrared detectors to detect infrared radiation emitted by a detection area on the surface of the item in relation to the heating area, and
a unit for processing signals supplied by the infrared detectors to construct a thermographic image of the surface of the item by scanning the surface through the heating area.

The invention applies in particular to the non-destructive testing of items to detect flaws, variations in the nature or properties of the materials thereof, differences in thickness of coating layers, local variations of thermal diffusivity or conductivity on or beneath the surface thereof, etc.

The items to be examined may be metallic and consist of ferrous materials, for example alloyed steels such as stainless steel, or non-ferrous materials. They may also be produced in composite materials, ceramics or plastic materials.

Photothermal examination is based on the phenomenon of diffusion of a thermal disturbance produced by local heating of the item to be examined.

In practice, a photothermal camera is used that emits a laser beam which is focused on the surface of the item being examined, in a heating area.

The infrared radiation emitted by the item in a detection area adjoining or merged with the heating area allows the rise in temperature of the detection area, due to heating in the heating area, to be measured or estimated.

The space between the heating area and the detection area is generally known as the “offset”. This offset may be zero such that the detection area and the heating area are in this case merged.

The infrared radiation and therefore the rise in temperature can be measured without contact by using a detector such as an infrared detector.

The infrared radiation or the rise in temperature in the detection area is influenced by the local characteristics of the materials being inspected. In particular, the heat diffusion between the heating area and the detection area which is the source of the rise in temperature in the detection area depends on flaws in the item being examined, such as cracks, in the region of the heating area or in the detection area or in the vicinity of these two areas.

By scanning the surface of the item to be examined through the heating area and detecting the radiation emitted by the detection area, which moves with the heating area during scanning, a thermographic image of the surface of the item can be obtained, which represents the variations of heat diffusion in the item or flaws present within the item.

Previously, a selected heating area and a single infrared detection were used to capture the radiation emitted by the detection area, which was also a specially selected area. The offset between the detection area and the heating area therefore needed to be adjusted very precisely using mechanical devices. Moreover, the surface scanning of the item was very lengthy so that this type of photothermal examination process was not used in practice on an industrial scale. To overcome these drawbacks, FR-2 760 528 (U.S. Pat. No. 6,419,387) proposed a camera of the aforementioned type.

The creation of an extended heating area, rather than a heating point, allows the scanning time to be reduced. Moreover, because of the matrix of detectors, it is possible to select a row of detectors from which a thermographic image of the item being examined will be constructed. This adjustment of the offset by selecting detectors in the matrix overcomes the need for the precise mechanical adjustment which is the current state of the art.

In this camera, the laser beam section is extended using a slit passed through by the laser beam.

Such a camera has proved satisfactory and can be used industrially.

However, it would be desirable to reduce further the scanning time, while maintaining the reliability of the examination that a camera of the aforementioned type can perform.

Accordingly, the invention relates to a photothermal examination camera of the aforementioned type, characterised in that the extension device is an optical device.

According to particular embodiments, the camera may comprise one or a plurality of the following characteristics, taken in isolation or in all the combinations that are technically possible:
the optical device comprises a lens designed to be passed through by the laser beam;
the optical device comprises a mirror for reflecting the laser beam;
the shaping system comprises a device for homogenising the power of the laser beam along the heating area;
the power homogenisation device is formed by the device for extending the section of the laser beam;
a face of the lens has a profile suitable for homogenising the power of the laser beam along the heating area;
a reflective face of the mirror has a profile suitable for homogenising the power of the laser radiation along the heating area;
the homogenisation device is a device for forming a line by causing the laser beam to move perpendicularly to its propagation direction;
the device comprises an acousto-optical cell;
the homogenisation device comprises an oscillating mirror;
the homogenisation device comprises a bundle of optical fibres, the upstream ends of which receive the laser beam and the downstream ends of which are arranged along a line to create the extended heating area;
the camera comprises a system for mechanically adjusting a space between the heating area and the detection area;
the camera comprises a box, and the mechanical adjustment system comprises a device for moving the matrix of infrared detectors in relation to the box;
the camera comprises a box, and the mechanical adjustment system comprises a device for moving the shaping system in relation to the box;
the movement device comprises a linear motor;
the movement device comprises a piezoelectric linear actuator;
the movement device comprises a rotary motor and a mechanism for transforming a rotary movement into a translation movement;
the camera comprises a filter blade to reflect the laser beam and transmit the infrared radiation radiated by the detection area towards the matrix of infrared detectors;
the blade comprises at least one material chosen from the list made up of CaF₂, MgF₂, Al₂O₃, BaF₂, Ge, ZnSe, ZnS FLIR, multispectral ZnS, MgO and SrF₂;
the camera comprises a system for scanning the surface of the item through the heating area;
the processing unit is suitable for adjusting a space between the heating area and the detection area by selecting a row of infrared detectors in the detection matrix;
the processing unit is suitable for processing independently signals supplied by each of the infrared detectors in the matrix; the camera comprises a laser source; and
the camera comprises connection means to a laser source that does not form part of the camera.

The invention will be better understood on reading the following description, given solely as an example and made with reference to the accompanying drawings, in which:

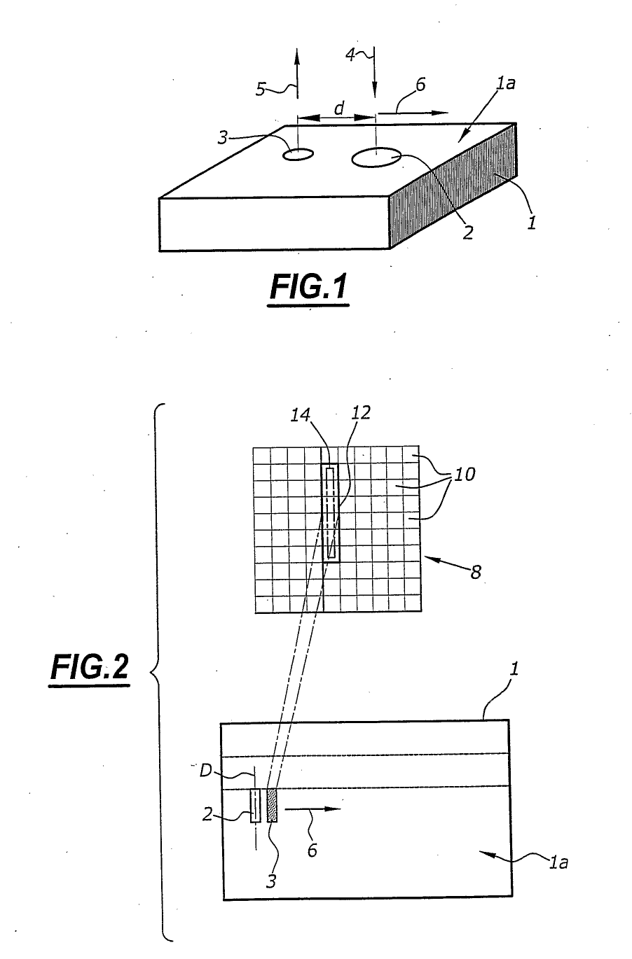

FIG. 1 is a diagrammatic perspective view illustrating the principles of photothermal examination,

FIG. 2 is a diagram illustrating a photothermal examination process used by a camera according to the invention,

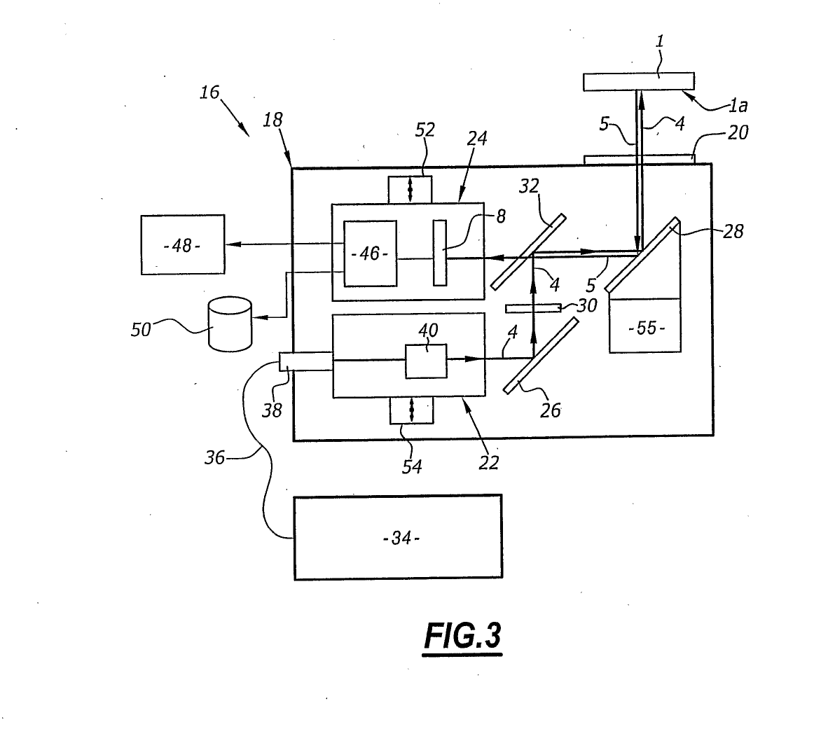

FIG. 3 is a diagrammatic view illustrating a photothermal examination camera according to a first embodiment of the invention,

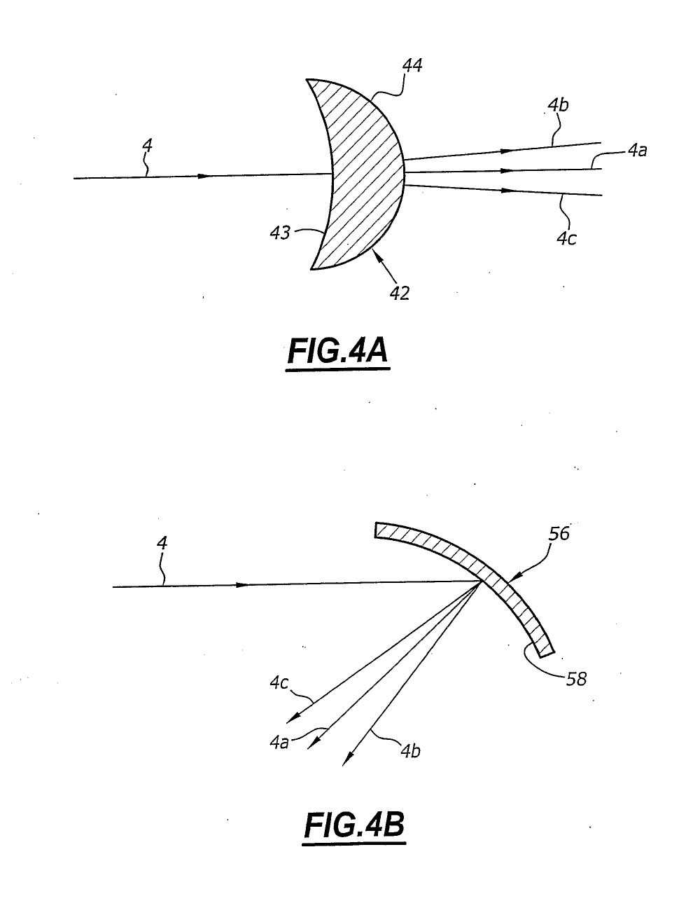

FIG. 4A is a diagrammatic cross-section illustrating, for the camera in FIG. 3, the device for extending the section of the laser beam,

FIGS. 4B, 5A, 5B and 6 are views similar to FIG. 4A illustrating variants of the device of FIG. 4A,

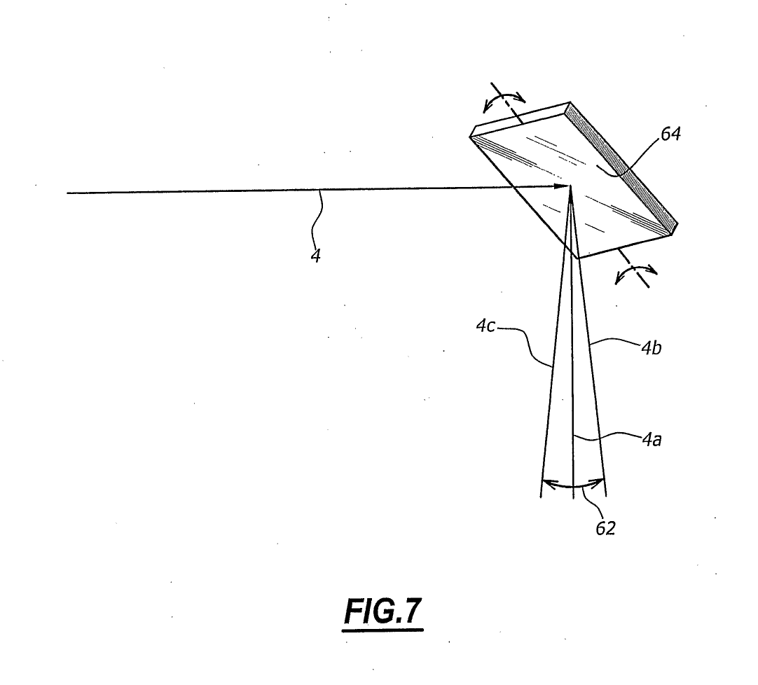

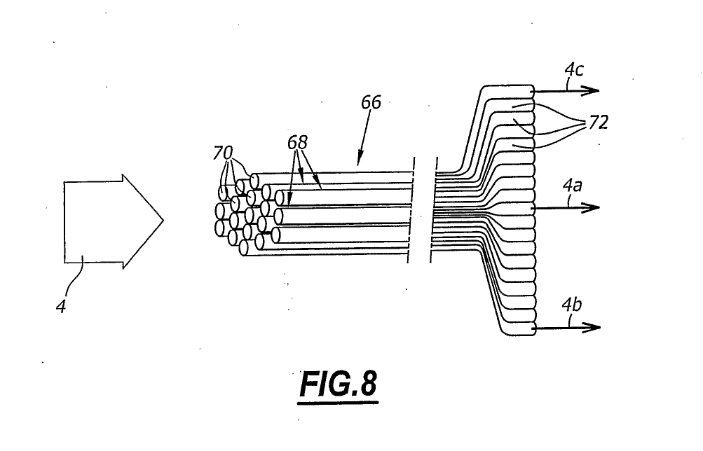

FIGS. 7 and 8 are diagrammatic figures illustrating two further variants of the device of FIG. 4A, and

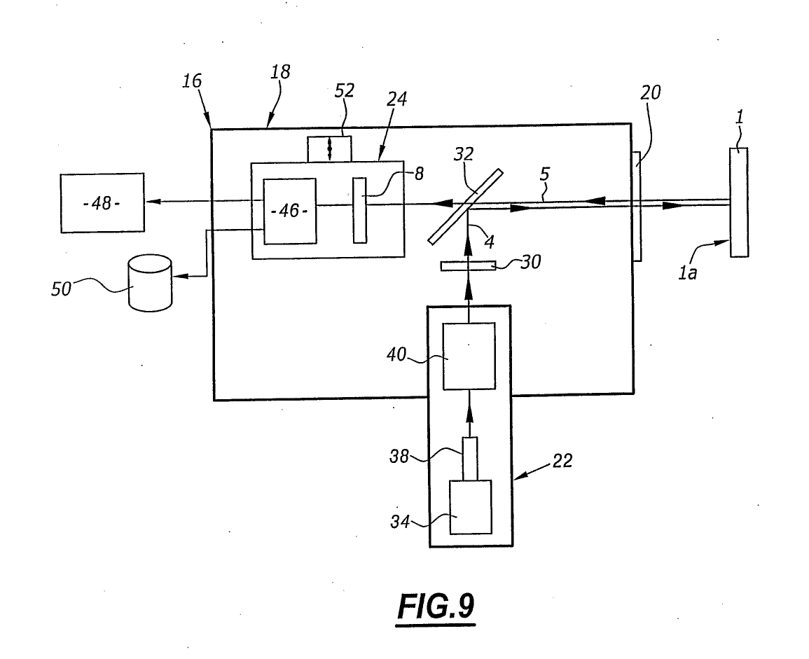

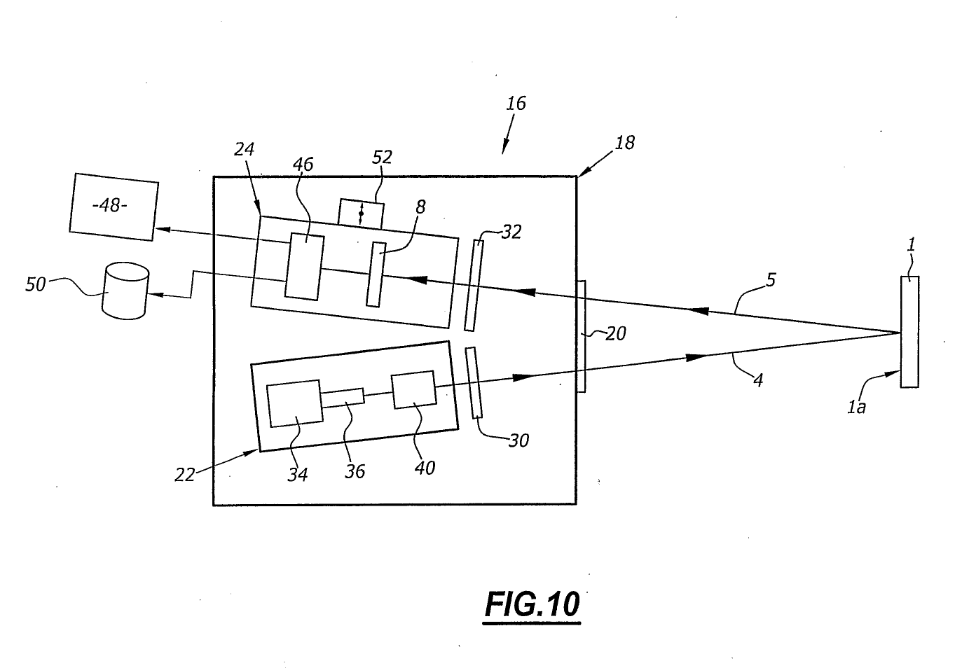

FIGS. 9 and 10 are diagrammatic views illustrating two other embodiments of a camera according to the invention.

As a reminder of the principles of photothermal examination, an item 1 for examination has been illustrated in FIG. 1. To examine it, its top surface 1a is scanned, by moving a heating area 2 and a detection area 3 synchronously, over the surface 1a. The heating area 2 and the detection area 3 are spaced from each other and separated by a distance d known as the offset. In some implementations, the offset d is zero and the areas 2 and 3 are merged.

The area 2 is heated by an incident laser beam, indicated by the arrow 4. The infrared radiation emitted by the detection area 3 is detected. This radiation is indicated by the arrow 5 in FIG. 1. The movement of areas 2 and 3 is indicated by the arrow 6.

The movement 6 is or is not parallel to the offset d between the heating area 2 and detection area 3. Scanning is performed line by line, for example, the direction of movement being reversed for each successive line (“notched” configuration) or being identical (“comb” configuration).

In FIG. 1, the heating area 2 is situated ahead of the detection area 3 in relation to the direction of movement 6. However, any other relative position is possible, as described in document FR-2 760 528 (U.S. Pat. No. 6,419,387), the content of which is here incorporated by reference.

FIG. 2 illustrates a photothermal examination process in which the heating area 2 is an area extended in the direction D. More specifically, the area 2 is in the form of a line but, in a variant, it may have another form, such as an ellipse.

The detection area 3 has a form similar to that of area 2. It will be noted that in the example in FIG. 2 it is situated ahead of the heating area 2 in relation to the direction of movement 6.

The use of an extended heating area 2 allows the time needed to scan the surface 1a to be reduced, as described in document FR-2 760 528 (U.S. Pat. No. 6,419,387). This characteristic is also present in the invention.

To detect the radiation emitted 5, a matrix 8 of infrared detectors 10 is used. The matrix 8 generally comprises M lines and N columns. The numbers M and N may vary independently of each other and may be between 1 and several hundred, for example, or even more.

As in FR-2 760 528 (U.S. Pat. No. 6,419,387), a row 12 of detectors 10 is selected within the matrix 8 to carry out the examination. The trace 14 of the radiation 5 emitted by the detection area 3 on the matrix 8 of detectors 10 has been illustrated in FIG. 2. As can be seen, the row 12 selected comprises in reality the detectors 10 illuminated by the infrared radiation emitted by the detection area 3.

In the invention, and as in FR-2 760 528 (U.S. Pat. No. 6,419,387), it is possible, by selecting a suitable row 12 of detectors 10, to adjust the offset d between the heating area 2 and detection area 3.

In practice, the incident laser beam emission 4 and the radiation detection 5 are performed preferably by the same camera.

FIG. 3 illustrates a photothermal examination camera 16 according to the invention.

This camera 16 comprises principally:
a box 18 provided with a transparent window 20,
a system 22 for shaping the laser beam 4,
a system 24 for detecting the radiation 5, and
two mirrors 26 and 28, a shutter 30 and a filter blade 32, these elements being inserted in the box 18 between the window 20, the shaping system 22 and the detection system 24 to send the shaped laser beam 4 towards the item 1 and send the radiation 5 towards the detection system 24 as will be seen in more detail below.

The shaping system 22 is connected to a laser source 34, by means of an optical fibre 36. The shaping system 22 comprises a collimator 38 and a device 40 for extending the section of the laser beam 4 emitted by the source 34.

The section of the beam 4 is thus extended perpendicularly to its propagation direction, to form the extended heating area 2.

As illustrated by FIG. 4A, the extension device 40 comprises a lens 42, passed through by the beam 4. This lens 42 is a divergent cylindrical lens.

The lens 42 causes divergence of the beam 4 in the direction in which the extension is to be produced. This direction is perpendicular to the propagation direction of the beam 4, as indicated by the arrows 4a to 4c in FIG. 4A which illustrate the lines of propagation of the beam 4 on exiting from the lens 42.

The plane in FIG. 4A contains the extension direction and the propagation direction of the beam 4. The plane in FIG. 4A is perpendicular to the plane in FIG. 3.

In the plane of FIG. 4A, the upstream face 43 and the downstream face 44 of the lens 42 have cross-sections that are substantially arcs of a circle. It will be noted that the lens 42 does not produce any extension of the section of the beam, and is therefore not divergent, in the plane of FIG. 3.

The detection system 24 comprises the matrix 8 of detectors 10 and a unit 46 for processing the signals emitted by the detectors 10 of the matrix 8. This unit 46 is suitable for processing the signals emitted by each of the detectors 10 independently, which allows, in particular, the row 12 of detectors 10 to be selected in order to adjust the offset.

More generally, the unit 46 controls the operation of the camera unit 16.

Traditionally, optical components not illustrated may be arranged in the system 24, upstream of the matrix 8 in relation to the propagation direction of the radiation 5, to ensure satisfactory operation of the matrix 8.

The unit 46 is suitable for constructing a thermographic image of the surface 1a of the item 1 by processing signals received from the detectors 10 of the selected row 12. The unit 46 may, for example, be connected to display means 48 of the thermographic image and to storage means 50 in order to store the processing data produced. In the example illustrated, the means 48 and 50 are at a distance from the camera 16, but, in a variant, they may form part thereof.

The blade 32 is semi-reflective to allow the laser beam 4 to be reflected while allowing the radiation 5 to pass through.

More precisely, the blade 32 allows:
the radiation 5 to pass through by using a substrate having a maximum transmission of the infrared flow in the spectral band corresponding to the temperatures to which the camera 16 brings the item 1 inspected locally, and
the laser beam 4 to be reflected by means of an interference filter (consisting of a stack of layers with different optical indices, placed on the surface of the substrate) allowing maximization of the reflectivity of the blade to the wavelength and angle of incidence of the beam 4.

To form the substrate of the blade 32, one or a plurality of the following materials may be used:

CaF₂ (calcium fluoride),

MgF₂ (magnesium fluoride),

Al₂O₃ (sapphire/aluminium oxide),

BaF₂ (barium fluoride),

Ge (germanium),

ZnSe (zinc selenide),

ZnS—FLIR (zinc sulphide—forward looking infrared),

multispectral ZnS (zinc sulphide),

MgO (magnesium oxide) and

SrF₂ (strontium fluoride).

The camera 16 comprises a device 52 for moving the detection system 24 in relation to the box 18. This movement system 52 allows the system 24, and thus the matrix 8 of detectors 10, to be moved perpendicularly to the radiation 5 upstream of the matrix 8. To do this, the movement device 52 may comprise, for example, a piezoelectric linear actuator, a linear motor or a rotary motor associated with a screw/nut mechanism to provide precise lateral movement of the detection system 24 perpendicular to the beam 5 in the plane of FIG. 3. Other mechanisms for transforming a rotary movement into a translation movement may be envisaged.

Similarly, the camera 16 also comprises a device 54 for moving the shaping system 22. This device 54 has, for example, a structure similar to that of the device 52 and allows the shaping system 22 to be moved perpendicularly to the propagation direction of the beam 4 exiting from the shaping system 22.

The camera 16 also comprises a device 55 allowing the mirror 28 to be moved in order to scan the surface 1a through the heating area 2 and the detection area 3. This movement device 55 comprises, for example, two galvanometers or two motors for scanning the surface 1a in two perpendicular directions.

In the camera 16, the mirror 26 reflects the laser beam 4 extended by the device 40 onto the shutter 30.

When the shutter 30 is open, it allows the beam 4 to pass through and said beam is reflected by the blade 32 towards the mirror 28 which itself reflects the beam 4 towards the surface 1a through the window 20.

The radiation 5 passes through the window 20, is reflected by the mirror 28 towards the blade 32 which it passes through to reach the detection system 24 and illuminate the matrix 8 of detectors 10.

The unit 46 can then construct a thermographic image of the surface 1a as the scanning progresses, the image being displayed by the display means 48.

By using an optical device 40, the loss of power of the laser beam is lower than in FR-2 760 528 (U.S. Pat. No. 6,419,387) where a slit was used to extend the section. This allows the scanning time of the surface 1 to be reduced and more effective use to be made of the power of the laser beam 4.

The choice of one or a plurality of the aforementioned materials to form the blade 32 ensures better performance of the blade 32 over time.

This helps improve the reliability of examinations carried out by the camera 16.

The movement devices 52 and 54 allow precise mechanical adjustment of the offset d between the heating area 2 and the detection area 3. It will be recalled that it may be desirable to conduct examinations with a zero offset d.

This precise adjustment, which can be controlled manually or by the processing unit 46, is in addition to the possibility of adjustment offered by the choice of the row 12 used. In cases where the trace 14 of the detection area 3 may be close to or may cross the boundary of the row 12 of detectors selected, the second mechanical offset adjustment opportunity allows the trace 14 to be relocated at the centre of the selected row 12.

This third aspect of the invention improves the quality of the thermographic image formed and thus increases the precision and reliability of examinations carried out using the camera 16.

It will be seen that each of these three aspects, that is, the use of an optical device 40, the nature of the blade 32 and the mechanical adjustment of the offset, may be used independently of the others.

Regarding the first aspect, the section extension device 40 may have a structure different from that described above while remaining an optical, not a physical device as in the current state of the art.

It may for example comprise a plurality of lenses, particularly cylindrical lenses.

Any lens having a different refractive power in the two axes perpendicular to the propagation direction of the laser beam 4 so as to obtain a beam of which the transverse section is greater along one axis than along the other, is understood to be a cylindrical lens.

Rather than having faces 43 and 44 with cross-sections of arcs of a circle, one of these lenses or the lens 42 used may have a face 44 or a plurality of faces of suitable profile(s) to homogenise the power.

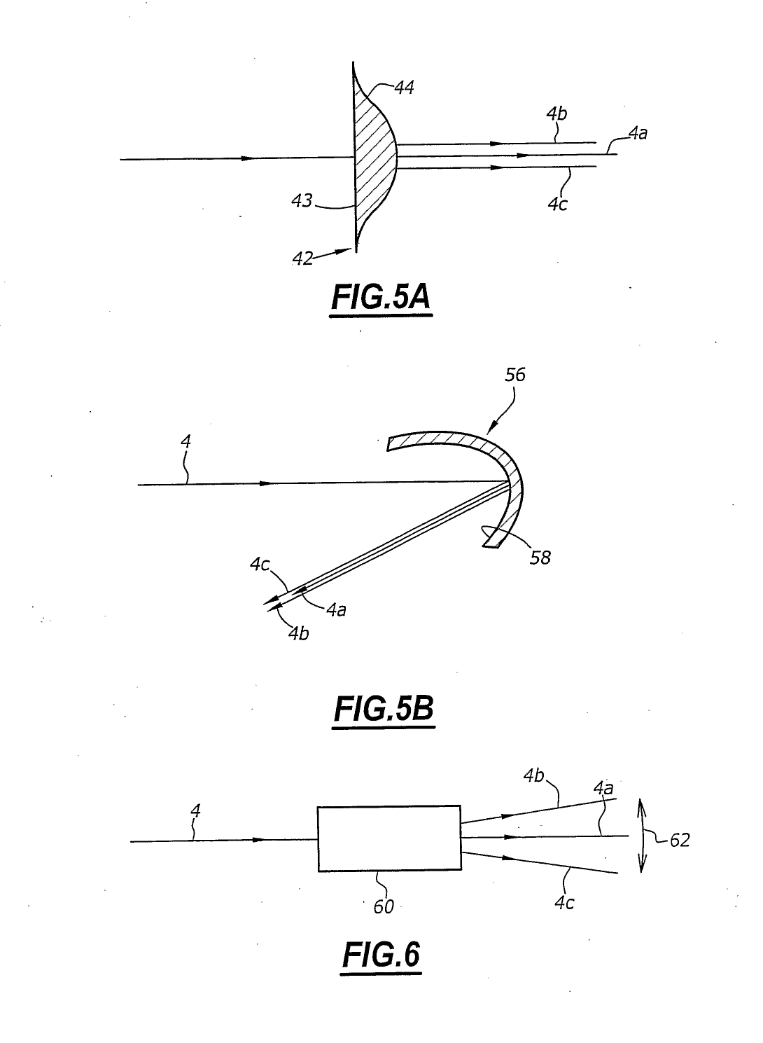

This is illustrated by FIG. 5A where the downstream face 44 of the lens 42 has a section different from an arc of a circle, this cross-section being of suitable profile to increase the homogeneity of the power of the laser beam 4 over the length of its section.

The extension device 40 in this case fulfils two functions, namely that of extending the section of the laser beam 4 and that of homogenising the power of the beam 4 over this length.

Power distribution along direction D of the heating area 2 being relatively homogeneous owing to the extension device 40, the image formed is sharp and photothermal examinations carried out using the camera 16 are reliable.

Instead of one or a plurality of lenses 42, the device 40 may comprise one or a plurality of mirrors, which, by reflection, provide the functions of section extension and perhaps power homogenisation. The device 40 may in this case comprise a mirror 56 one face 58 of which reflects the beam 4 and has a section in an arc of a circle or a section having a profile suitable for homogenising the power.

Such mirrors 56 and the reflecting faces 58 thereof are illustrated in FIGS. 4B and 5B respectively.

It will be observed that, in the examples above, the laser beam section is extended by increasing said section along one dimension. In a variant, this extension may be brought about by reducing the width of the beam section.

Similarly, depending on the device 40 used, the collimator 38 may be eliminated.

The device 40 may also, in a variant, provide the functions of extending the section and possibly homogenising the power by causing the laser beam 4 to move. In this case, the optical device 40 may comprise, for example, an acousto-optical cell 60. As illustrated in FIG. 6, this acousto-optical cell 60 extends the section of the beam 4 by moving the beam along the direction where its section is to be extended. This movement is indicated by the double arrow 62 in FIG. 6.

In a variant, as illustrated in FIG. 7, the laser beam 4 may be made to move by an oscillating mirror 64.

FIG. 8 illustrates yet another variant. The optical device 40 in this case comprises a bundle 66 of optical fibres 68 the upstream ends of which receive the laser beam 4 and the downstream ends 72 of which are aligned so that on exit they produce a laser beam 4 with an extended section.

Further variants may also be envisaged. In particular, the functions of extending the section on the one hand and homogenising the power on the other hand, may be performed by two distinct devices.

Regarding the mechanical adjustment of the offset, it is not necessary for the camera 16 to have both a device 52 for moving the detection system 24 and a device 54 for moving the shaping system 22.

It may in fact comprise only one of these devices.

This is illustrated in FIG. 9 where the camera 16 comprises only one device 52 for moving the shaping system 24.

The structure of the camera 16 is further simplified in that the laser source 34 has been integrated into the camera 16 and in that the mirrors 26 and 28 have been eliminated.

Moreover, the camera 16 in FIG. 9 does not comprise an integrated movement device 55 for scanning the surface 1a.

In this case, scanning is performed by a device for moving the item 1 or by a device for moving the camera 16 situated outside said camera.

More generally, mechanical adjustment of the offset d used in addition to the programmed adjustment by selection of the row 12 may be performed using devices for moving one or a plurality of optical components arranged between the shaping system 22, the detection system 24 and the item 1 to be examined. It is not essential therefore to move the shaping system 22 or the detection system 24.

Further embodiments may also be envisaged.

In particular, the incident beam 4 on the item 1 and the infrared beam 5 emitted are not necessarily parallel but may be inclined in relation to each other, as illustrated diagrammatically in FIG. 10 by way of example.

In FIG. 10, the blade 32 serves as a protection filter for the detectors 10 of the matrix 8.

In similar fashion, it is not essential to use a filter blade.

1. Camera (16) for photothermal examination, of the type that comprises:
a system (22) for shaping a laser beam (4) comprising a device (40) for extending the section of the beam to form a heating area (2) extended in one direction (D), on the surface of an item (1) to be examined,
a matrix (8) of infrared detectors (10) to detect infrared radiation emitted by a detection area (3) on the surface (1a) of the item (1), and
a unit (46) for processing signals supplied by the infrared detectors (10) to construct a thermographic image of the surface (1a) of the item (1) by scanning the surface (1a) through the heating area (2),
wherein the extension device (40) is an optical device.

2. Camera according to claim 1, wherein the optical device (40) comprises a lens (42) designed to be passed through by the laser beam (4).

3. Camera according to claim 1, wherein the optical device (40) comprises a mirror (56) designed to reflect the laser beam (4).

4. Camera according to claim 1, wherein the shaping system (22) comprises a device (40) for homogenising the power of the laser beam (4) along the heating area (2).

5. Camera according to claim 4, wherein the power homogenisation device is formed by the laser beam section extension device (40).

6. Camera according to claim 2, wherein one face (44) of the lens (42) has a profile suitable for homogenising the power of the laser beam (4) along the heating area (2).

7. Camera according to claim 3, wherein one reflecting face (58) of the mirror (56) has a profile suitable for homogenising the power of the laser radiation (4) along the heating area (2).

8. Camera according to claim 5, wherein the homogenisation device (40) is a device for forming a line by causing the laser beam (4) to move perpendicularly to its propagation direction.

9. Camera according to claim 8, wherein the device (40) comprises an acousto-optical cell (60).

10. Camera according to claim 8, wherein the homogenisation device (40) comprises an oscillating mirror (64).

11. Camera according to claim 5, wherein the homogenisation device (40) comprises a bundle (66) of optical fibres (68) the upstream ends (70) of which receive the laser beam (4) and the downstream ends of which are arranged along a line to create the extended heating area (2).

12. Camera according to claim 1, wherein it comprises a system (52, 54) for mechanical adjustment of a space d between the extended heating area (2) and the detection area (3).

13. Camera according to claim 12, wherein it comprises a box (18), and in that the mechanical adjustment system comprises a device (52) for moving the matrix (8) of infrared detectors (10) in relation to the box (18).

14. Camera according to claim 12, wherein it comprises a box (18), and in that the mechanical adjustment system comprises a device (54) for moving the shaping system (22) in relation to the box (18).

15. Camera according to claim 13, wherein the movement device (52, 54) comprises a linear motor.

16. Camera according to claim 13, wherein in that the movement device (52, 54) comprises a piezoelectric linear actuator.

17. Camera according to claim 13, wherein the movement device (52, 54) comprises a rotary motor and a mechanism for transforming a rotary movement into a translation movement.

18. Camera according to claim 1, wherein in that it comprises a filter blade (32) to reflect the laser beam (4) and transmit the infrared radiation (5) radiated by the detection area (3) towards the matrix (8) of infrared detectors (10).

19. Camera according to claim 18, wherein the blade comprises at least one material chosen from the list made up of CaF₂, MgF₂, Al₂O₃, BaF₂, Ge, ZnSe, ZnS FLIR, multispectral ZnS, MgO and SrF₂.

20. Camera according to claim 1, wherein it comprises a system for scanning the surface (1a) of the item (1) through the heating area (2).

21. Camera according to claim 1, wherein the processing unit (46) is suitable for adjusting a space (d) between the heating area (2) and the detection area (3) by selecting a row (12) of infrared detectors (10) in a detection matrix (8).

22. Camera according to claim 1, wherein the processing unit (46) is suitable for the independent processing of signals provided by each of the infrared detectors (10) of the matrix (8.)

23. Camera according to claim 1, wherein it comprises a laser source (34).

24. Camera according to claim 1, wherein it comprises connection means (36) to a laser source (34) that does not form part of the camera.
